(19) United States
(12) Patent Application Publication
(10) Pub. No.: US 2026/0237572 A1
(43) Pub. Date: Aug. 13, 2026

(54) BATTERY CONFIGURATION CONTACTOR ASSEMBLY

(71) Applicant: SENSATA TECHNOLOGIES, INC., ATTLEBORO, MA (US)

(72) Inventors: PAULUS THOMAS JOHANNES GENNISSEN, MARKELO (NL); SANDER JOHANNES GERARDUS PAS, RIJSSEN (NL); ERNIE JOHANNUS ANTONIUS SCHOOT UITERKAMP, HEETEN (NL); ENGBERTUS BERKEL, WIERDEN (NL)

(21) Appl. No.: 19/416,473

(22) Filed: Dec. 11, 2025

Related U.S. Application Data
(60) Provisional application No. 63/755,564, filed on Feb. 7, 2025.

(51) Int. Cl. H01H 3/38; H01H 9/02; H01M 50/503

(52) U.S. Cl. CPC H01H 3/38; H01H 9/02; H01M 50/503; H01H 2235/01

(57) ABSTRACT

Exemplary methods and apparatuses for a battery configuration contactor assembly are disclosed. A battery configuration contactor assembly is disclosed that includes a housing, a cam shaft, and a first cam and a second cam mounted to the cam shaft. The contactor assembly also includes a first switch including a first lever carrying a first movable contact and cooperating with a first fixed contact. In addition, the contactor assembly also includes a second switch including a second lever carrying a second movable contact and cooperating with a second fixed contact. In this embodiment, the contactor assembly also includes a tension spring coupled between the first lever and the second lever. Profiles and angular orientations of the first and second cams are selected such that the first switch and the second switch are in opposite states, and rotation of the cam shaft indexes the assembly among a plurality of electrical connection states.

### BACKGROUND

Electromechanical switching devices, such as contactors and relays, are designed to carry a certain amount of electrical current for certain periods of time. Such devices are particularly important in electric vehicles. Typically, electric vehicles have multiple electromechanical switches that open or close high current paths between the battery packs and the electrical system. These switches are controlled by different actuation mechanisms. To prevent short circuit of the battery packs, electromechanical switching elements of the battery configuration contactor must withstand mechanical shock and coordinate multiple switches to change a battery connection configuration.

### SUMMARY

The following summary is meant to help one skilled in the art understand the various presently disclosed combinations of features. It is not meant to unduly limit the scope of any pending or future claims relating to the disclosure.

In various embodiments, a compact battery configuration contactor assembly uses a motor-driven cam shaft carrying cams to actuate three lever-type switches, with a shared tension spring between two levers that enforces opposite states and reduces required actuation torque. Cam profiles and angular orientation index the assembly among discrete electrical states including open, series, parallel, and optionally battery-only states. In some embodiments, a modular architecture provides a first housing portion containing a first switch and a second housing portion containing second and third switches, all driven by the same shaft, allowing single and dual switch modules to be combined. Levers may be produced by stamp-and-form techniques and bus bars may be shortened and shaped to maintain desired forces during high-current events while facilitating creepage and clearance. A controller may drive the motor to discrete setpoints using position feedback to ensure repeatable state selection and reporting. The architecture reduces component count and control complexity while enabling compact packaging and manufacturability.

In a particular embodiment, a battery configuration contactor assembly is disclosed that includes a housing, a cam shaft, and a first cam and a second cam mounted to the cam shaft. The contactor assembly also includes a first switch including a first lever carrying a first movable contact and cooperating with a first fixed contact. In addition, the contactor assembly also includes a second switch including a second lever carrying a second movable contact and cooperating with a second fixed contact. In this embodiment, the contactor assembly also includes a tension spring coupled between the first lever and the second lever. Profiles and angular orientations of the first and second cams are selected such that the first switch and the second switch are in opposite states, and rotation of the cam shaft indexes the assembly among a plurality of electrical connection states.

In another embodiment, a modular battery configuration contactor assembly is disclosed that includes a first housing portion and a second housing portion, an actuator housing containing a motor and a cam-shaft receiver, and a cam shaft driven by the motor. The contactor assembly also includes a first cam, a second cam, and a third cam on the cam shaft. In this embodiment, the contactor assembly also includes a first switch in the first housing portion including a first lever coupled between a first connection point and a second connection point. The contactor assembly includes a second switch in the second housing portion including a second lever coupled between a third connection point and a fourth connection point. In this embodiment, the contactor assembly also includes a third switch in the second housing portion including a third lever coupled between a fifth connection point and a sixth connection point. The first, second, and third levers are respectively actuated by the first, second, and third cams on the common cam shaft.

In another embodiment, a method of operating a battery configuration contactor assembly is disclosed that includes providing a contactor assembly including a housing, a cam shaft, cams mounted to the cam shaft, and first, second, and third switches each including a lever carrying a movable contact and cooperating with a fixed contact. The method also includes rotating the cam shaft to actuate the first, second, and third switches via the cams. In addition, the method also includes selecting among a plurality of electrical connection states by indexing the cam shaft.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

One or more aspects of the present disclosure are discussed below with reference to the accompanying Figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element.

Further, where considered appropriate, reference numerals may be repeated among the drawings to indicate corresponding or analogous elements. For purposes of clarity, however, not every component may be labeled in every drawing. The Figures are provided for the purposes of illustration and explanation and are not intended to be limiting. In the Figures:

FIG. 1A illustrates an exploded view of a compact battery configuration contactor assembly in accordance with at least one embodiment of the present disclosure.

FIG. 1B illustrates an assembled portion of the compact battery configuration contactor assembly of FIG. 1A.

FIG. 1C illustrates a side view of the compact battery configuration contactor assembly of FIG. 1A.

FIG. 1D illustrates a bottom view of the compact battery configuration contactor assembly of FIG. 1A.

FIG. 1E illustrates another side view of the compact battery configuration contactor assembly of FIG. 1A.

FIG. 2 is a flowchart of an example method of operating a compact battery configuration contactor assembly according to at least one embodiment of the present disclosure.

FIG. 3A illustrates a cross-section view of a first side of a compact battery configuration contactor assembly in an all open state in accordance with at least one embodiment of the present disclosure.

FIG. 3B illustrates a cross-section view of a second side of the compact battery configuration contactor assembly of FIG. 3A in the all open state in accordance with at least one embodiment of the present disclosure.

FIG. 3C illustrates a block diagram of a system that includes a battery configuration contactor assembly in the all open state in accordance with at least one embodiment of the present disclosure.

FIG. 3D illustrates a cross-section view of the first side of the battery configuration contactor assembly of FIG. 3A in a parallel connection state in accordance with at least one embodiment of the present disclosure.

FIG. 3E illustrates a cross-section view of the second side of the battery configuration contactor assembly of FIG. 3A in the parallel connection state in accordance with at least one embodiment of the present disclosure.

FIG. 3F illustrates a block diagram of the system of FIG. 3C that includes the battery configuration contactor assembly in the parallel connection state in accordance with at least one embodiment of the present disclosure.

FIG. 3G illustrates a cross-section view of the first side of the battery configuration contactor assembly of FIG. 3A in a series connection state in accordance with at least one embodiment of the present disclosure.

FIG. 3H illustrates a cross-section view of the second side of the battery configuration contactor assembly of FIG. 3A in the series connection state in accordance with at least one embodiment of the present disclosure.

FIG. 3I illustrates a block diagram of the system of FIG. 3C that includes the battery configuration contactor assembly in the series connection state in accordance with at least one embodiment of the present disclosure.

FIG. 4A illustrates an exploded view of a battery configuration contactor assembly in accordance with at least one embodiment of the present disclosure.

FIG. 4B illustrates an assembled portion of the battery configuration contactor assembly of FIG. 4A.

FIG. 4C illustrates an assembled portion of the compact battery configuration contactor assembly of FIG. 4A with the outer housing removed.

FIG. 5 is a flowchart of another example method of operating a battery configuration contactor assembly according to at least one embodiment of the present disclosure.

FIG. 6 is a flowchart of another example method of operating a battery configuration contactor assembly according to at least one embodiment of the present disclosure.

FIG. 7 is a flowchart of another example method of operating a battery configuration contactor assembly according to at least one embodiment of the present disclosure.

### DETAILED DESCRIPTION

In the following detailed description, various combinations of embodied features are disclosed in order to provide one skilled in the art an understanding of the aspects and implementations of the present disclosure. It will be understood by those of ordinary skill in the art that those may be practiced without some of the specific details that are set forth. In some instances, well-known methods, procedures, components and structures may not be described in detail so as not to obscure the details of the implementations of the present disclosure. The following detailed description is not meant to unduly limit any present or future claim scope in this or subsequent related applications. This disclosure may use different names, or different numerical identifiers, to describe the same feature or partially the same part. Further, where considered appropriate, reference numerals may be repeated among the drawings to indicate corresponding or analogous elements. For purposes of clarity, however, not every component may be labeled in every drawing.

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure.

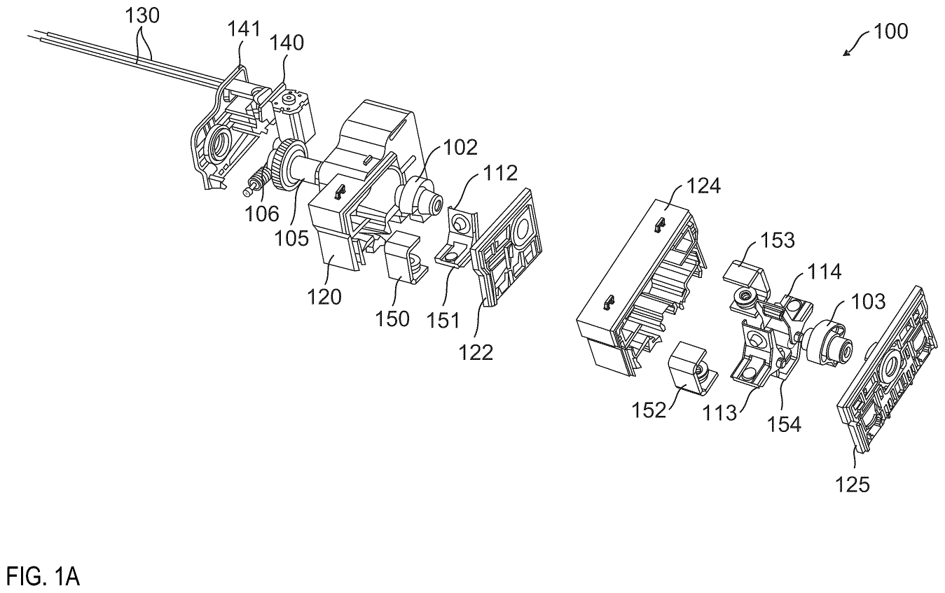

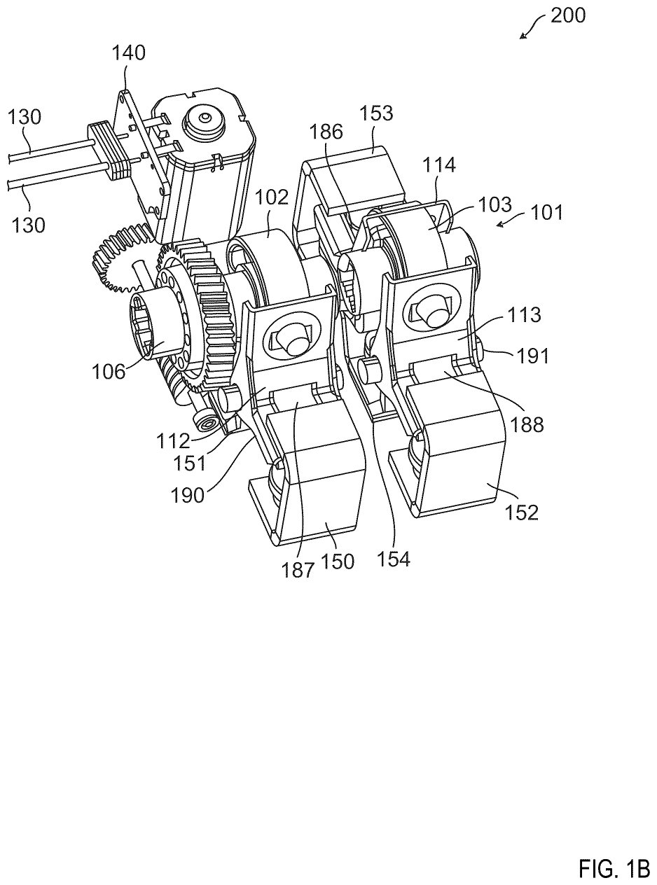

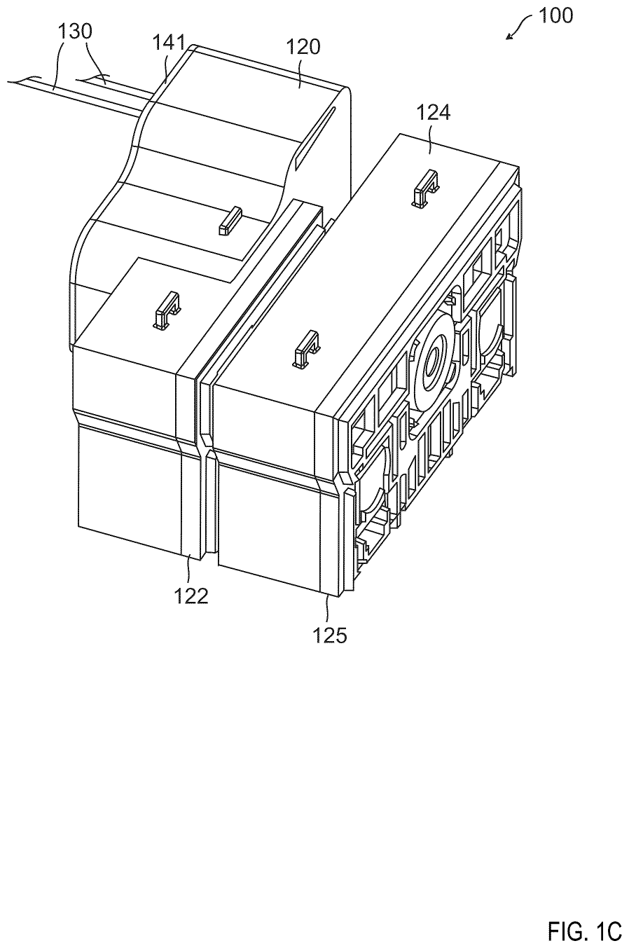

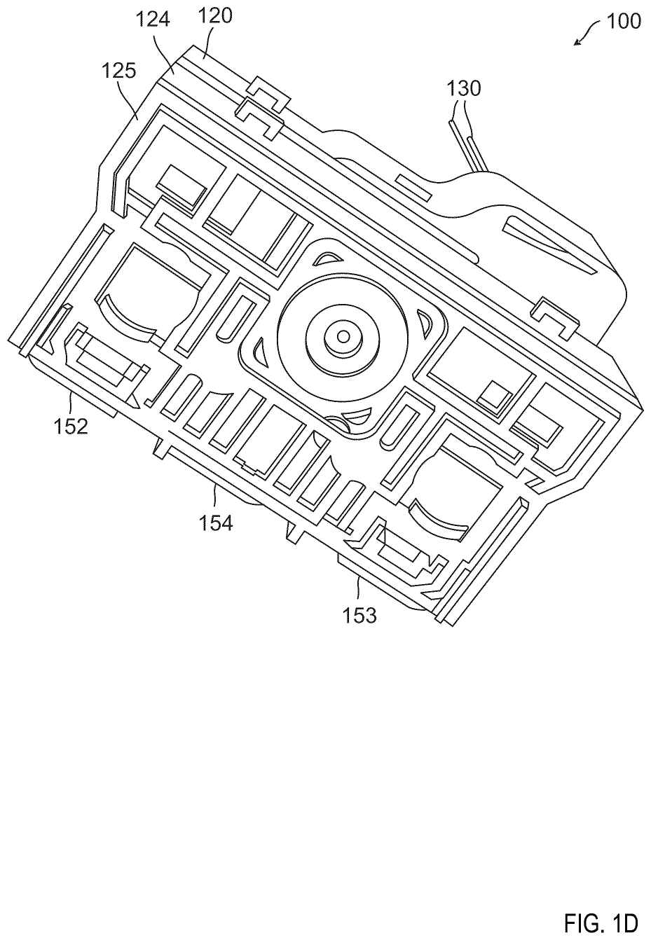

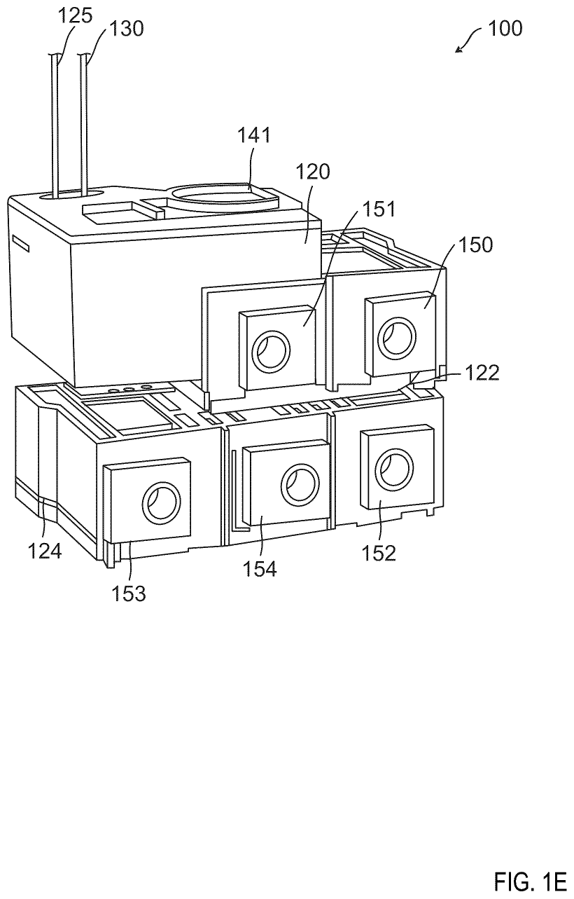

Exemplary methods and apparatuses for a battery configuration contactor assembly in accordance with the present disclosure are described with reference to the accompanying drawings, beginning with FIG. 1A. FIG. 1A sets forth an exploded view of a compact battery configuration contactor assembly 100 in accordance with at least one embodiment of the present disclosure. For further explanation, FIG. 1B sets forth an assembled portion 200 of the compact battery configuration contactor assembly 100 of FIG. 1A. FIG. 1C illustrates a side view of the compact battery configuration contactor assembly 100 of FIG. 1A. FIG. 1D sets forth a bottom view of the compact battery configuration contactor assembly 100 of FIG. 1A. Finally, FIG. 1E illustrates another side view of the compact battery configuration contactor assembly 100 of FIG. 1A. For ease of illustration and explanation, not all of the components of the compact battery configuration contactor assembly 100 are illustrated in every figure.

The compact battery configuration contactor assembly 100 includes a cam assembly 101 including two cams 102, 103 that are coupled to a cam shaft 105, where rotation of the cam shaft is driven by a motor 106. In the example of FIGS. 1A-1B, the motor 106 is controlled by a printed circuit board (PCB) 140 that receives command signals via electrical wires 130. The compact battery configuration contactor assembly 100 includes a first switch assembly 190 and a second switch assembly 191. The first switch assembly 190 includes two fixed contacts 150, 151 and a first rocker 112 with a moveable contact 187. The second switch assembly 191 includes three fixed contacts 152, 153, 154, a second rocker 113 with a moveable contact 188, and third rocker 114 with a moveable contact 186. In a particular embodiment, the compact battery configuration contactor assembly 100 may be employed in an electric vehicle for connecting multiple battery packs to a vehicle power distribution system for driving the electric vehicle as well as for charging the battery packs.

In the example of FIGS. 1A-B, the fixed contacts are substantially C-shaped having an inner surface and an outer surface. In this example, the moveable contacts of the rockers 112, 113, 114 are oriented to contact the inner surface of the respective fixed contacts.

In a particular embodiment, the cams 102, 103 have portions that are round shaped and flat shaped. The different shapes of the cams 102, 103 allow the cam to interact with the respective rockers 112, 113, 114 to change the states (opened, closed) of the respective switches. It will be appreciated that other cam shapes may be utilized instead of a cam having round portions and flat portions. For example, a notch may be employed instead of a flat façade. In a particular embodiment, the switch assemblies include ‘normally closed’ switches. In other examples, the switch assemblies may comprise ‘normally open’ switches, where a lobe or other protruding actuation member applies a force on the rocker to make contact with the fixed contact and close the switch. In some variations, combinations of ‘normally open’ and ‘normally closed’ switches may be used in the same array of switches.

It will be appreciated that two or more cams having different cam shapes may be employed to realize different switch states in the corresponding switches. Similarly, two or more cams having the same shape but different orientations on the cam shaft may be employed to realize different switch states in the corresponding switches. In some cases, two cams may have the same shape and the same orientation on the cam shaft such that the cams actuate the same switch state on the corresponding switches (e.g., to reduce the current per contact). Thus, the multiple cams corresponding to the multiple switches may vary by shape, orientation, or alignment, where all cams are actuated by the same cam shaft.

The compact battery configuration contactor assembly 100 may be applied in a battery configuration contactor as well as other devices constructed as above with different cam shape to enable high voltage high current connections that require low contactor resistance, like fast charging contactors, or that require no device current consumption, like axillary contactors used, for example, in vehicle to grid systems.

The assembled portion 200 illustrated in FIG. 1B is illustrated in FIGS. 1A, 1C, 1D, and 1E encased by a first housing portion 120 having a first lid 141 and a bottom plate 122 and a second housing portion 124 having a bottom portion 125. In a particular embodiment, the first housing portion 120 and the second housing portion 124 are a single solid housing that holds the contacts, motor, and driving gears.

In some examples, the compact battery configuration contactor assembly 100 includes a position sensor (not shown) to detect the rotation of the cam shaft 105. The position sensor provides the absolute angle of the cam shaft such that the cam shaft can be rotated to a new setpoint to change switch states. The position sensor may be, for example, a non-contacting position sensor and a contacting device (e.g., a potentiometer). The signal of the position sensor can be used to both control the cam shaft position and to communicate the state of the contacts to the vehicle controller. In this example, state selection can either be achieved by driving the internal cam shaft to a hard stop and/or counting the motor revolutions (and from there derive the position), and/or use of an (angular) position sensor to determine if the motor should be powered on or not and in which direction.

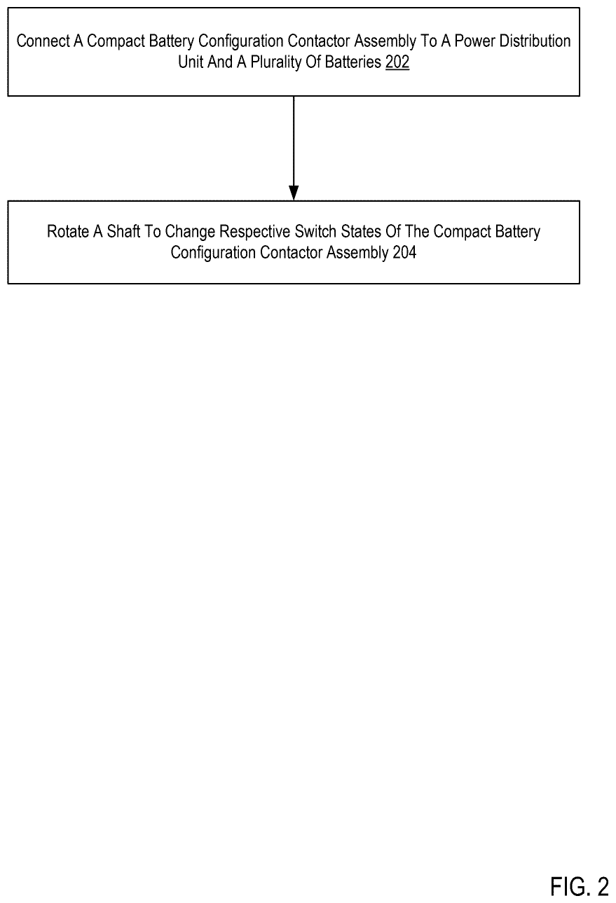

For further explanation, FIG. 2 sets forth a flow chart illustrating an example method of operating a compact battery configuration contactor assembly in accordance with at least one embodiment of the present disclosure. The method of FIG. 2 includes connecting 202 the compact battery configuration contactor assembly to a power distribution unit and a plurality of batteries. In some examples, the compact battery configuration contactor assembly may be any of the compact battery configuration contactor assembly 100 described above.

The method of FIG. 2 also includes rotating 204 the shaft to change the respective switch states of the switches of the compact battery configuration contactor assembly. Rotation of the cam shaft to change the switch states is described above. Rotation of the cam shaft rotates the cams. In each switch, a cam, depending on its rotational orientation, engages a rocker attached to the moveable contact and causes rotation of the rocker, which moves the moveable contact into or out of contact with the fixed contact. The cam shaft rotates multiple cams at the same time, which changes the switch states of the switches.

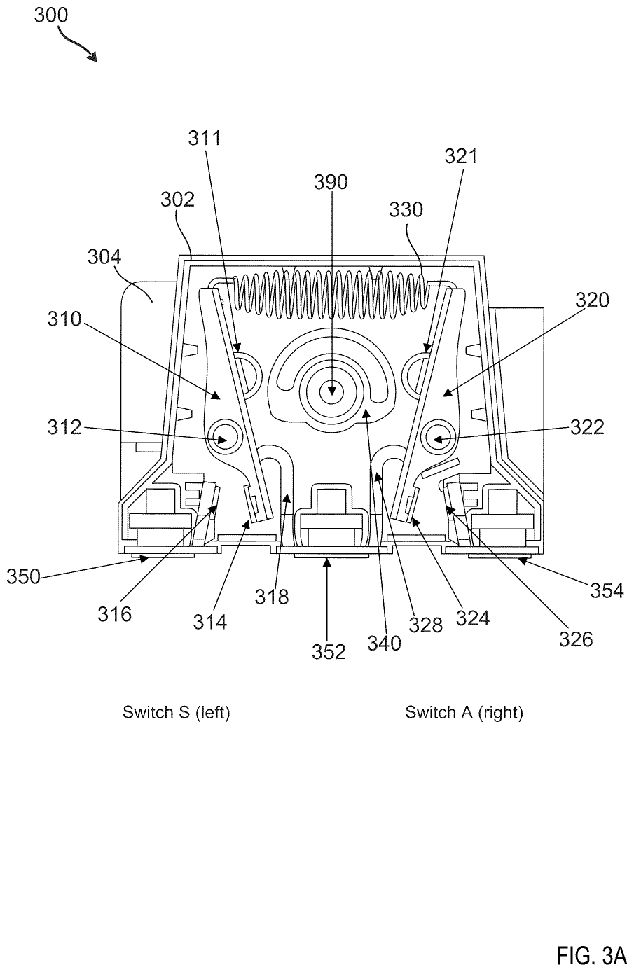

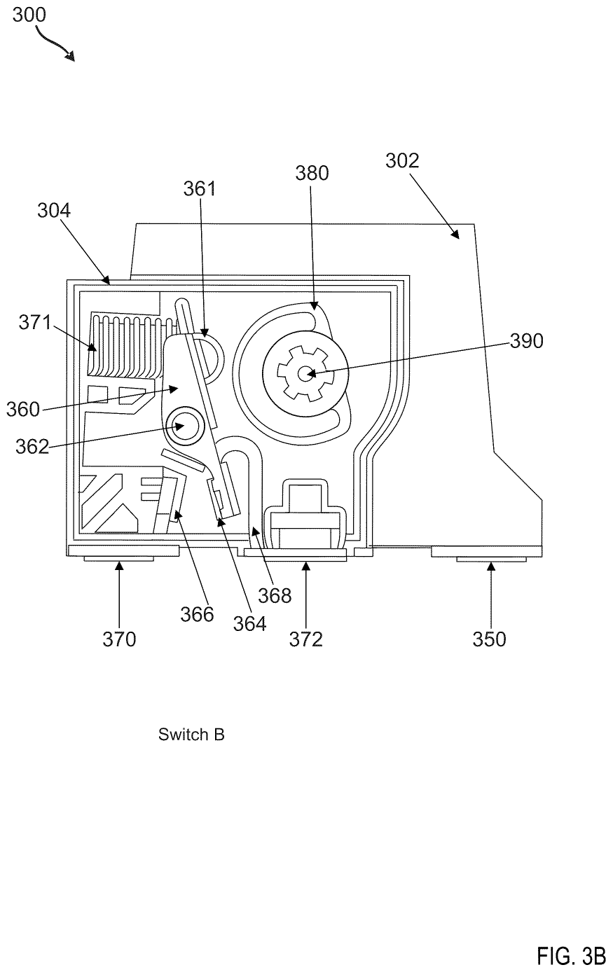

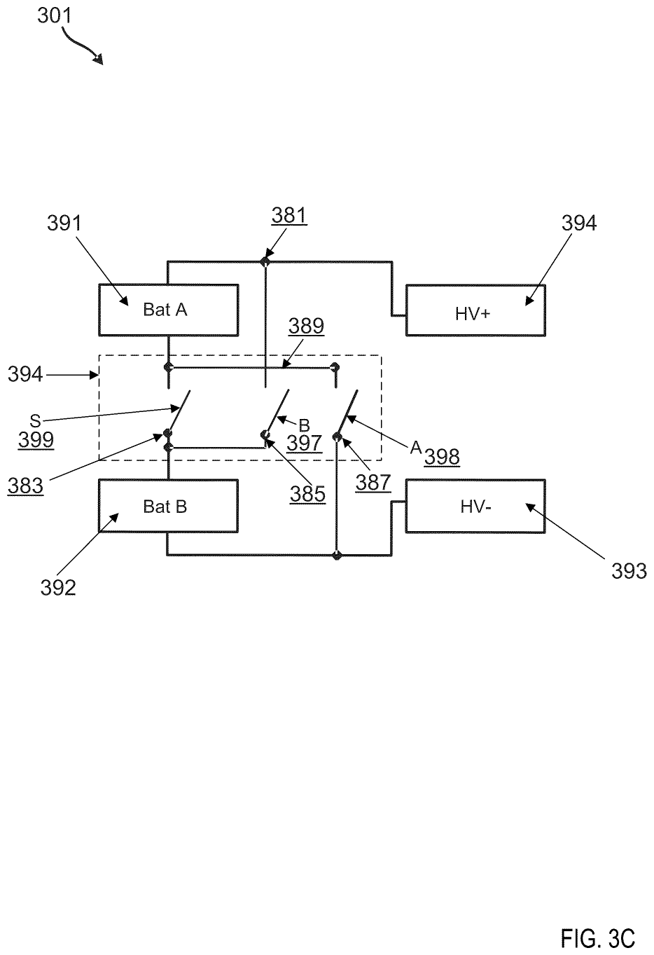

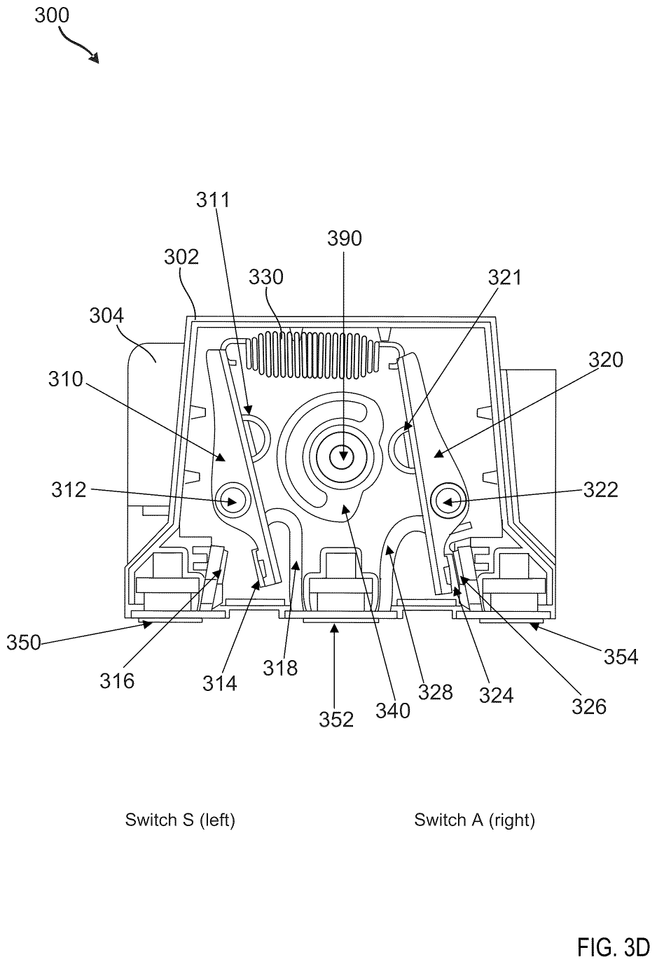

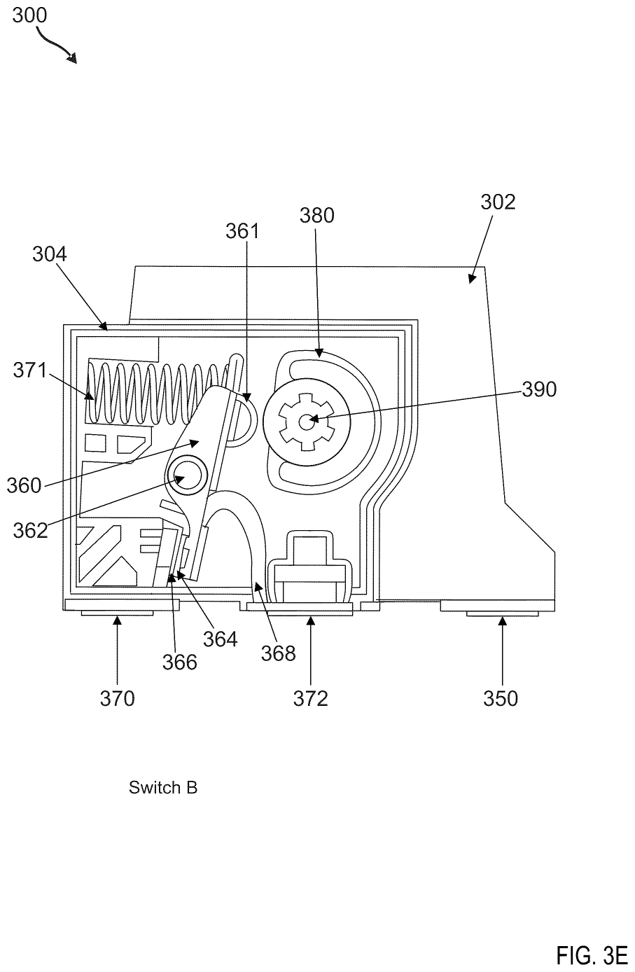

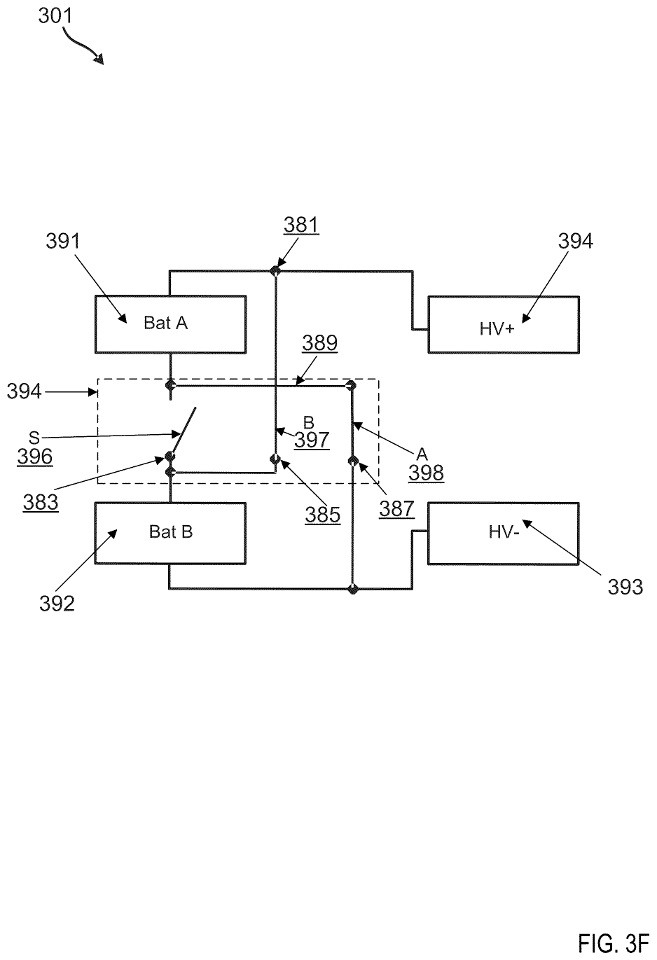

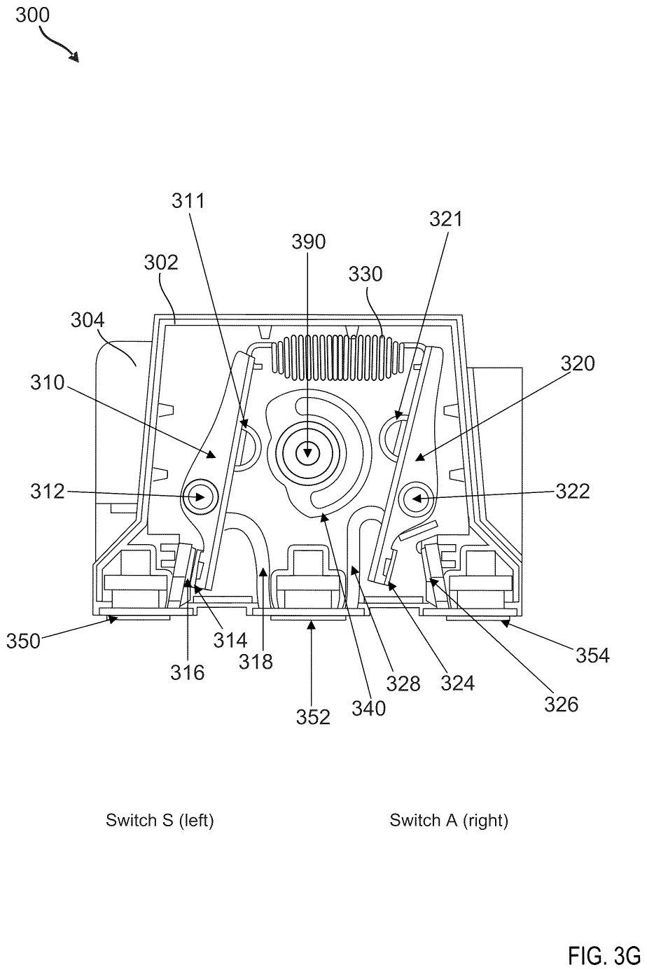

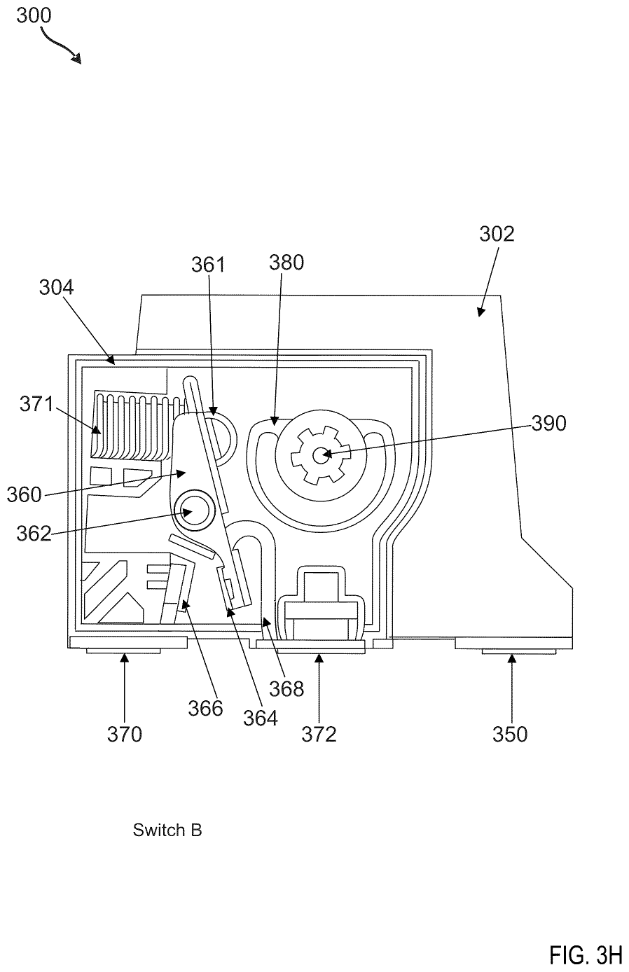

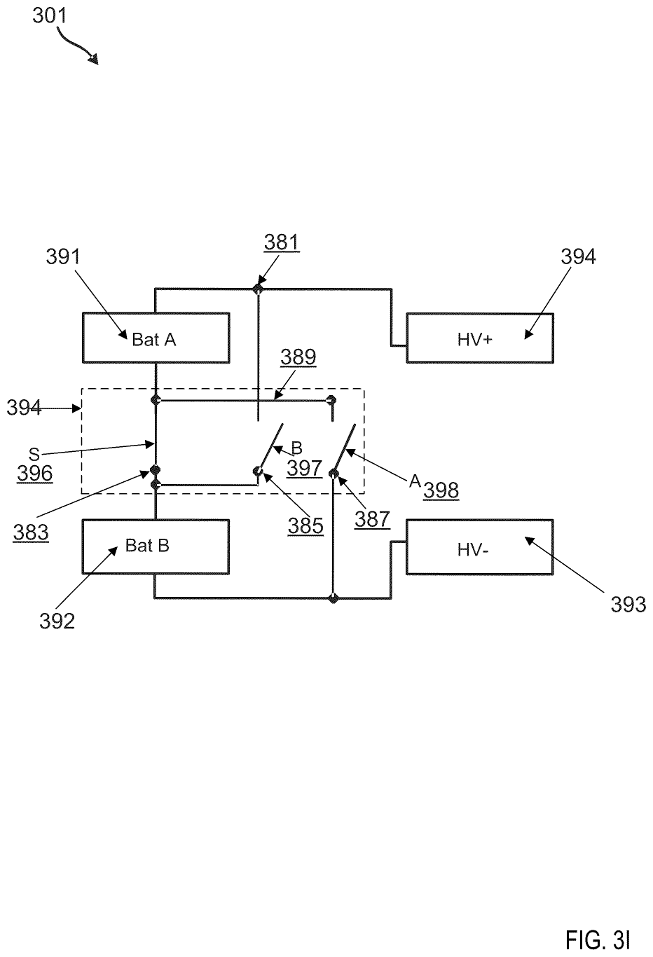

For further explanation, FIGS. 3A-3I illustrate a battery configuration contactor assembly 300 configured to selectively interconnect two batteries in different configurations. The assembly employs three mechanically coordinated switches—identified as “A,” “S,” and “B”—that are actuated by cams mounted to a common cam shaft 390. By appropriate actuation of the switches, the assembly can establish multiple connection states, including open, series, and parallel configurations between the batteries and high-voltage terminals.

As shown in FIG. 3A, the contactor assembly 300 includes a main switch housing 302 and a secondary switch housing 304. The main housing 302 encloses the components of the “A” and “S” switches, while the secondary housing 304 encloses the components of the “B” switch. Each switch is actuated by a corresponding cam that converts rotational motion of the cam shaft 390 into pivoting movement of a lever. Each lever supports a movable contact that cooperates with a corresponding fixed contact to open or close an electrical circuit path. Rotation of the cam shaft 390—driven by an electric motor—simultaneously actuates all three levers, thereby coordinating the switching states.

The “A” switch in the main housing 302 includes a first lever 310 having a first rocker 311 coupled through a first lever connection path 318 to a third connection point 352. The lever 310 includes a first lever coupler 314 positioned to engage a first connection-point coupler 316 that is electrically connected to a first connection point 350. The lever 310 pivots about a third lever connector 362 such that, when actuated to the closed position, the couplers 314 and 316 engage to establish an electrical current path between the first and third connection points 350, 352. When the lever 310 pivots to the open position, the couplers 314 and 316 separate, interrupting the circuit between the first and third connection points. The mechanical arrangement of the lever, rocker, and couplers is configured to maintain reliable contact pressure when closed while ensuring rapid and complete disengagement upon opening.

The “S” switch in the main housing 302 includes a second lever 320 having a second rocker 321 coupled through a second lever connection path 328 to the same third connection point 352. The second lever 320 includes a second lever coupler 324 configured to engage a second connection-point coupler 326 that is electrically connected to a second connection point 354. When closed, the “S” switch completes a circuit path between the third and second connection points 352, 354. When open, the couplers 324 and 326 are separated. The first and second levers 310 and 320 are positioned such that their free ends move in opposite directions when actuated, minimizing the lateral space required for both mechanisms within the same housing.

A shared tension spring 330 connects the upper ends of the first and second levers 310, 320 at locations opposite their respective couplers. The spring 330 provides contact force to the lever that is in the closed position while simultaneously biasing the opposite lever to the open position. The tension spring thus maintains the two switches (“A” and “S”) in opposite states—when the “A” switch is closed, the “S” switch is open, and vice versa. This mechanical coupling simplifies the actuation system by reducing the number of individual biasing elements and ensuring that the two switches cannot be closed simultaneously. The shared spring also reduces the torque required to rotate the cam shaft by balancing opposing spring forces.

A first cam 340 mounted to the cam shaft 390 within the main housing 302 controls the pivoting of the “A” and “S” levers. The cam 340 includes multiple cam lobes and flat regions that sequentially engage cam followers coupled to the levers 310 and 320. The angular orientation and profile shape of the cam 340 determine which lever is actuated at a given shaft position. For example, when the cam 340 rotates to a first angular position, it depresses the follower associated with lever 310, closing the “A” switch while releasing the follower associated with lever 320, allowing the “S” switch to open. When the cam 340 rotates to a second angular position, the roles reverse—lever 310 is released and lever 320 is depressed—closing the “S” switch and opening the “A” switch. In this manner, the first cam 340 provides alternating actuation of the “A” and “S” switches using a single rotational drive source.

As shown in FIG. 3B, the secondary switch housing 304 contains the “B” switch, which includes a third lever 360 having a third rocker 361 coupled through a third lever connection path 368 to a fifth connection point 372. The lever 360 includes a third lever coupler 364 positioned to engage a fourth connection-point coupler 366 that is electrically connected to a fourth connection point 370. When the “B” switch is closed, an electrical circuit path is established between the fourth and fifth connection points. When the “B” switch is open, the couplers 364 and 366 are separated, breaking the circuit. The lever 360 pivots about an axis parallel to the levers in the main housing, ensuring synchronized operation when the cam shaft is rotated.

The “B” lever 360 is actuated by a second cam 380 mounted on the same cam shaft 390. The angular orientation and profile of the second cam 380 are synchronized with the first cam 340 so that the “B” switch operates in phase with the “A” switch. Thus, when the “A” switch is closed, the “B” switch is also closed, and when the “A” switch is open, the “B” switch is likewise open. A tension spring 371 biases the “B” lever toward the open position, ensuring positive separation of its contacts when the cam 380 is rotated to an open-state profile.

Together, the three switches form a coordinated switching arrangement. The “A” and “B” switches move in unison, while the “S” switch operates in the opposite phase. This coordination allows controlled reconfiguration of two battery packs between different connection modes. The mechanical linkage between the switches, springs, and cams ensures consistent sequencing of contact engagement and disengagement, minimizing the risk of short-circuit conditions during transitions between states.

FIG. 3C depicts a system 301 incorporating the contactor assembly 394, which corresponds functionally to the assembly 300 described above. The system 301 includes a first battery 391, a second battery 392, a high-voltage positive terminal (HV+) 394, and a high-voltage negative terminal (HV−) 393. The “A,” “S,” and “B” switches selectively interconnect the batteries 391 and 392 with the HV terminals according to the positions of the cams on the cam shaft 390.

FIGS. 3D-3F illustrate the parallel-connection state. In FIG. 3D (main housing), the “A” switch is closed and the “S” switch is open. In FIG. 3E (secondary housing), the “B” switch is closed. As shown schematically in FIG. 3F, this configuration connects the two batteries 391, 392 in parallel between the HV+terminal 394 and the HV-terminal 393. The closed “A” and “B” switches provide the parallel current paths, while the open “S” switch isolates the interconnection between the battery midpoints.

FIGS. 3G-3I illustrate the series-connection state. In FIG. 3G, the “A” switch is open and the “S” switch is closed. In FIG. 3H, the “B” switch is open. As shown in the schematic diagram of FIG. 3I, this arrangement connects the two batteries 391, 392 in series between the HV+terminal 394 and the HV-terminal 393. The closed “S” switch connects the midpoint of the first battery to the terminal of the second battery, thereby creating a series circuit through the two battery packs.

When the “A,” “S,” and “B” switches are all open, the assembly is in the all-open state shown in FIGS. 3A-3C, fully isolating both batteries from the high-voltage system. In some embodiments, the cam shaft 390 may also be driven to additional intermediate angular positions to produce configurations in which only one battery is connected (battery-A-only or battery-B-only). Accordingly, the assembly can achieve five discrete electrical states: open, parallel, series, battery-A-only, and battery-B-only.

In certain embodiments, a position sensor (not pictured) is coupled to the cam shaft 390 to provide an absolute angular position signal to a controller (not pictured). The controller uses the signal to determine or confirm the switching state and to command precise rotation of the cam shaft to defined angular setpoints. The integrated cam and spring arrangement reduces mechanical complexity, lowers actuation torque, and enables compact, repeatable, and cost-effective construction suitable for high-current switching applications such as electric vehicle power distribution systems.

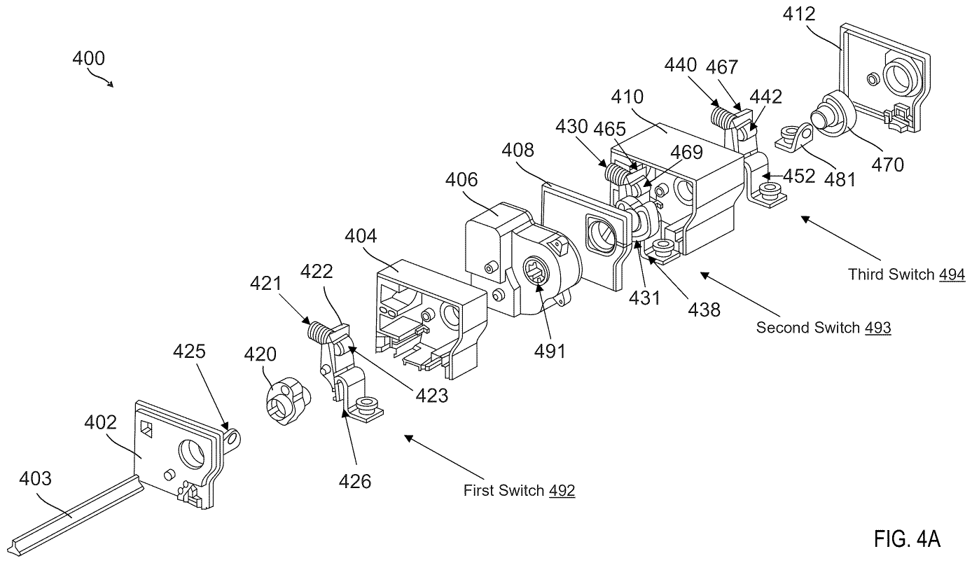

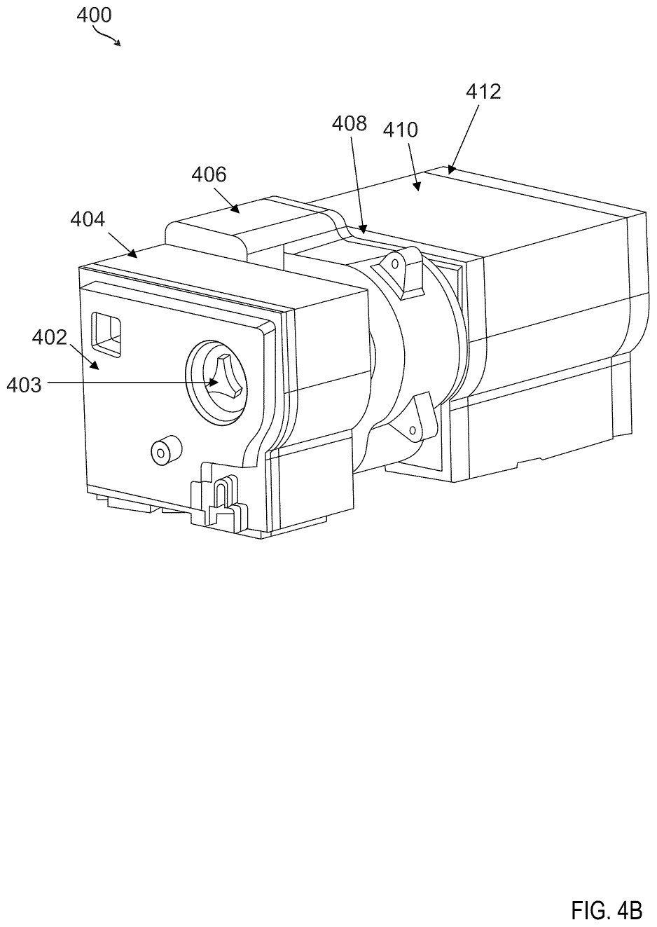

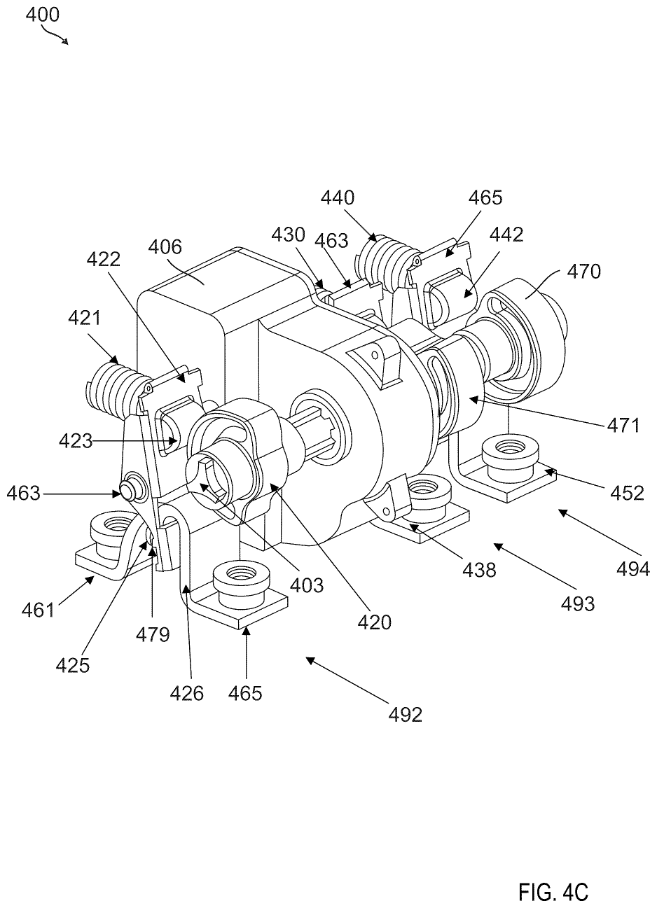

For further explanation, FIGS. 4A-4C illustrate a battery configuration contactor assembly 400 according to one embodiment of the present disclosure. FIG. 4A shows an exploded view of the assembly 400, FIG. 4B shows an assembled view with the housings in place, and FIG. 4C shows the same assembly with portions of the housings removed to reveal internal components. The assembly 400 provides multiple individually actuated switch mechanisms arranged along a common cam shaft, allowing compact packaging and coordinated operation of multiple high-current contacts.

The assembly 400 includes a first housing portion 404 and a second housing portion 410. Together, the housings support three switch mechanisms—a first switch 492, a second switch 493, and a third switch 494—each operated by a corresponding cam mounted to the common cam shaft 403. The housings are enclosed by a first cover 402 positioned over the first housing portion 404, and by second and third covers 408, 412 positioned over the second housing portion 410. The covers protect the switches from environmental exposure and provide electrical insulation between adjacent switch compartments.

An actuator housing 406 is coupled to one end of the assembly 400. The actuator housing 406 contains a motor that drives a cam-shaft receiver 491, which transmits torque to the cam shaft 403. The motor and receiver combination forms a compact drive module capable of rotating the cam shaft to selected angular positions corresponding to desired switch states. In some embodiments, the actuator housing may also include a position sensor for providing shaft-angle feedback to a controller (not pictured).

As shown in FIGS. 4A and 4C, the first housing portion 404 contains the first switch 492. The first switch 492 includes a first lever 422 pivotally mounted on a lever connector 463 and supporting a first rocker 423 for engaging with a first cam 420. The first lever 422 is mechanically coupled to a first lever coupler 479 configured to engage a first connection-point coupler 425 electrically tied to a first connection point 461. The lever 422 is also coupled through a first lever connection path 426 to a second connection point 465. When the first switch 492 is actuated to its closed position, the couplers 425 and 479 engage to complete an electrical circuit between the first connection point 461 and the second connection point 465. When opened, the couplers 425 and 479 are separated, interrupting the circuit. The lever 422 pivots about its connector 463 to open and close the contacts in response to rotation of the first cam 420 mounted to the cam shaft 403 interfacing with the first rocker 422.

A spring 430 acts between the first lever 422 and the housing 404 to bias the lever toward the open position and to provide defined contact pressure when closed. The geometry of the lever and cam allows high contact force with a relatively low cam-shaft torque, enabling compact, cost-effective actuation.

The second housing portion 410 contains the second switch 493 and the third switch 494, which are similar in structure and function to the first switch 492. For clarity, FIGS. 4A-4C show only portions of these switches. The second switch 493 includes a second lever 463, a second rocker 469, and a second spring 430 arranged about a pivot connection. The second lever 463 is coupled by a second connection path 438 between third and fourth connection points and includes a lever-coupler and a connection-point coupler (not separately labeled in the Figures). The second lever 463 is actuated by a second cam 471 mounted to the cam shaft 403. Rotation of the cam 471 about the shaft 403 engages with the second rocker 469 which moves the lever 463 between open and closed positions, alternately engaging and disengaging the corresponding electrical contacts.

Similarly, the third switch 494 includes a third lever 465, a third rocker 442, and a third spring 440, coupled through a third connection path 452 between fifth and sixth connection points. A third lever coupler 481 is configured to engage a corresponding connection-point coupler to establish or interrupt an electrical circuit when the lever 465 pivots. The third lever 465 is actuated by the third rocker 442 engaging with a third cam 470 mounted on the cam shaft 403. As with the other switches, the cam profile and spring bias cooperate to provide defined contact motion and pressure.

Each of the cams 420, 471, 470 on the cam shaft 403 can be configured with a distinct angular orientation, profile, or lobe shape, allowing the three switches 492, 493, 494 to be actuated simultaneously, sequentially, or in independent combinations. This flexibility enables the contactor assembly 400 to perform multiple switching functions within a single compact mechanical package. The common cam-shaft design also simplifies motor control, allowing coordinated actuation of multiple power paths with a single drive source.

In one embodiment, the switches 492, 493, 494 are positioned along the cam shaft 403 such that their axes of rotation are parallel and aligned in a common plane, minimizing overall height and simplifying assembly. The housing portions 404, 410 and the covers 402, 408, 412 include molded features for electrical isolation and mechanical rigidity. The switch modules are arranged so that each housing compartment can be individually assembled, tested, and enclosed prior to final integration with the actuator housing 406.

In a particular embodiment, the cams 420, 471, 470 have portions that are round shaped and flat shaped. The different shapes of the cams allow the cam to interact with the respective rockers 423, 469, 442 to change the states (opened, closed) of the respective switches. It will be appreciated that other cam shapes may be utilized instead of a cam having round portions and flat portions. For example, a notch may be employed instead of a flat façade. In a particular embodiment, the switch assemblies include ‘normally closed’ switches. In other examples, the switch assemblies may comprise ‘normally open’ switches, where a lobe or other protruding actuation member applies a force on the rocker to make contact with the fixed contact and close the switch. In some variations, combinations of ‘normally open’ and ‘normally closed’ switches may be used in the same array of switches.

It will be appreciated that three or more cams having different cam shapes may be employed to realize different switch states in the corresponding switches. Similarly, three or more cams having the same shape but different orientations on the cam shaft may be employed to realize different switch states in the corresponding switches. In some cases, three cams may have the same shape and the same orientation on the cam shaft such that the cams actuate the same switch state on the corresponding switches (e.g., to reduce the current per contact). Thus, the multiple cams corresponding to the multiple switches may vary by shape, orientation, or alignment, where all cams are actuated by the same cam shaft.

The modular arrangement illustrated in FIGS. 4A-4C allows one or more switch modules to share a single actuator housing 406 and cam shaft 403. For example, the first switch 492 may be used as a single module, while the second and third switches 493, 494 may form a dual-switch module, both driven by the same cam shaft and motor. The modules can be mounted on a common carrier or base structure to form different contactor configurations depending on the application. This modularity enables production flexibility, reduced manufacturing cost, and simplified adaptation to various electrical system architectures.

Accordingly, the assembly 400 provides a compact, manufacturable multi-switch contactor architecture. The coordinated cam and lever mechanisms allow precise, repeatable switching motion, while the modular housings and common actuation mechanism permit reuse of components across different configurations. The design facilitates efficient assembly, electrical isolation among switches, and scalable implementation for systems requiring one or multiple high-current switching elements.

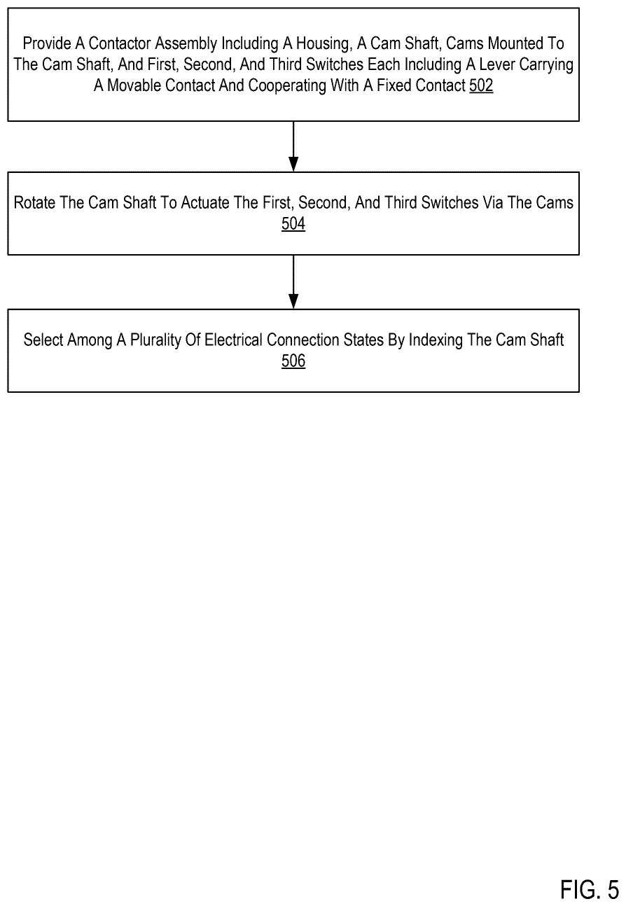

For further explanation, FIG. 5 sets forth a flowchart of another example method of operating a battery configuration contactor assembly according to at least one embodiment of the present disclosure. The method of FIG. 5 includes providing 502 a contactor assembly including a housing, a cam shaft, cams mounted to the cam shaft, and first, second, and third switches each including a lever carrying a movable contact and cooperating with a fixed contact. Providing 502 may be carried out by assembling a housing (e.g., 302/304 or 404/410) that supports a cam shaft 390/403, mounting cams 340 and 380 (or 420, 470, 471) to the shaft, installing first, second, and third switch subassemblies with levers 310, 320, 360 and rockers 311, 321, 361 (or levers 422, 463, 465 and rockers 423, 469, 442), coupling springs 330 and 371 (or 430 and 440), and completing electrical terminations to connection points 350, 354, 352, 370, 372 via couplers 314/316, 324/326, and 364/366 along paths 318, 328, 368. The assembly may further include coupling the cam shaft to a motor in actuator housing 406 via a cam-shaft receiver 491, enclosing the switches with covers 402, 408, 412 to establish creepage and clearance, and verifying indexing by rotating the shaft to positions that produce the open, parallel, and series configurations shown in FIGS. 3A-3I and 4A-4C.

The method of FIG. 5 also includes rotating 504 the cam shaft to actuate the first, second, and third switches via the cams. Rotating 504 may be carried out by driving the cam shaft 390/403 with a motor in actuator housing 406 through a cam-shaft receiver 491 so that cams 340 and 380 (or 420, 470, 471) engage with rockers 340, 380 (or 423, 469, 442) to sweep their profiles past cam followers to pivot levers 310, 320, 360 (or 422, 463, 465), thereby alternately engaging and separating lever-side couplers 314/324/364 from connection-point couplers 316/326/366 along paths 318, 328, 368. The cam profiles and angular orientations index the shaft to discrete setpoints that synchronize the first and third switches and phase the second switch oppositely, with springs 330, 371 (or 430, 440) providing contact force and return bias to realize the open, parallel, and series configurations shown in FIGS. 3A-3I and 4A-4C.

In addition, the method of FIG. 5 also includes selecting 506 among a plurality of electrical connection states by indexing the cam shaft. Selecting 506 may be carried out by commanding a controller to drive the cam shaft 390/403 to discrete angular setpoints (e.g., θ₀, θ_P, θ_S) using feedback from a position sensor so that cams 340 and 380 (or 420, 470, 471) place levers 310, 320, 360 (or 422, 463, 465) into the required open/closed combinations. For example, at θ₀ all switches open to isolate batteries 391, 392 from HV+ 394 and HV− 393 (FIGS. 3A-3C); at θ_P the first and third switches close while the second opens to connect the batteries in parallel (FIGS. 3D-3F); and at θ_S the first and third open while the second closes to connect the batteries in series (FIGS. 3G-3I), with equivalent indexing applicable in the modular embodiment of FIGS. 4A-4C.

This method improves prior designs by using a single cam-shaft indexing operation to synchronize three switches—keeping the first and third in phase and the second in opposite phase—so state changes (open, parallel, series, and optional battery-only states) occur in a defined sequence that avoids cross-connection and reduces control complexity. Mechanical phasing replaces multiple independent actuators and logic, cutting component count and failure modes, while the shared tension spring between two levers supplies contact force with lower cam-shaft torque for faster or lower-power actuation. The approach supports precise, repeatable setpoints (with optional position sensing) to guarantee the commanded electrical configuration, improving safety and diagnostics. In modular embodiments, the same indexing drives single and dual switch modules on a common shaft, enabling reuse of subassemblies and covers to lower manufacturing cost and simplify scaling to different applications. Overall, the method delivers safer transitions, reduced actuation load, and better manufacturability without sacrificing configuration flexibility.

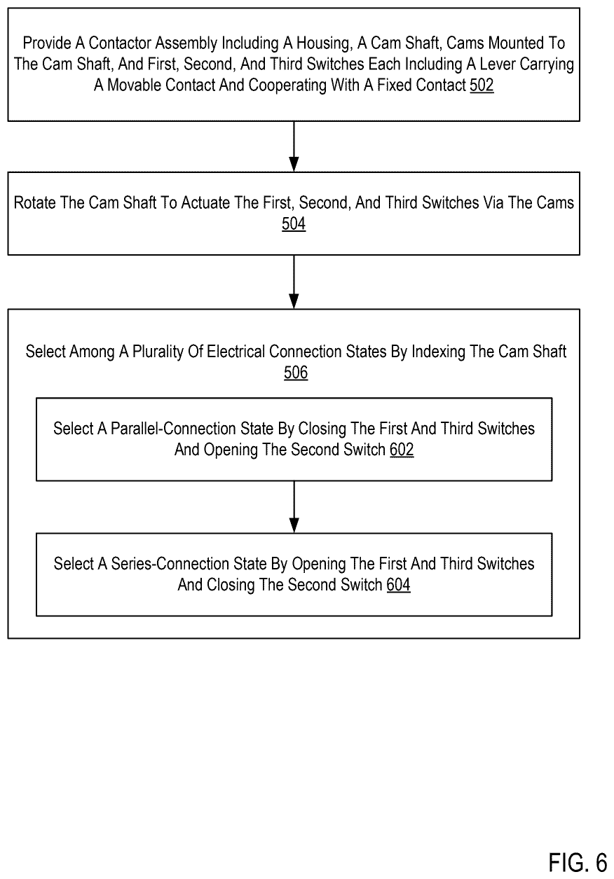

For further explanation, FIG. 6 sets forth a flowchart of another example method of operating a battery configuration contactor assembly according to at least one embodiment of the present disclosure. The method of FIG. 6 is similar to the method of FIG. 5 in that the method of FIG. 6 includes all of the steps of FIG. 5.

However, in the method of FIG. 6, selecting 506 among a plurality of electrical connection states by indexing the cam shaft includes selecting 602 a parallel-connection state by closing the first and third switches and opening the second switch. Selecting 602 may be carried out by indexing the cam shaft 390/403 so that cams 340 and 380 (or 420, 470, 471) drive the first and third switches closed while releasing the second switch—engaging couplers 314 with 316 and couplers 366 with 364, with couplers 324 and 326 separated. At this setpoint, the system-level result (FIG. 3F) is a parallel connection of batteries 391 and 392 between HV+ 394 and HV− 393.

In the method of FIG. 6, selecting 506 among a plurality of electrical connection states by indexing the cam shaft also includes selecting 604 a series-connection state by opening the first and third switches and closing the second switch. Selecting 604 may be carried out by indexing the cam shaft 390/403 so that cams 340 and 380 (or 420, 470, 471) release the first and third switches while driving the second switch closed—leaving couplers 316 and 314, and 366 and 364, separated, and engaging couplers 324 with 326 to complete path 354→326→324→328→352. At this setpoint, the system-level result (FIG. 3I) is a series connection of batteries 391 and 392 between HV+ 394 and HV− 393.

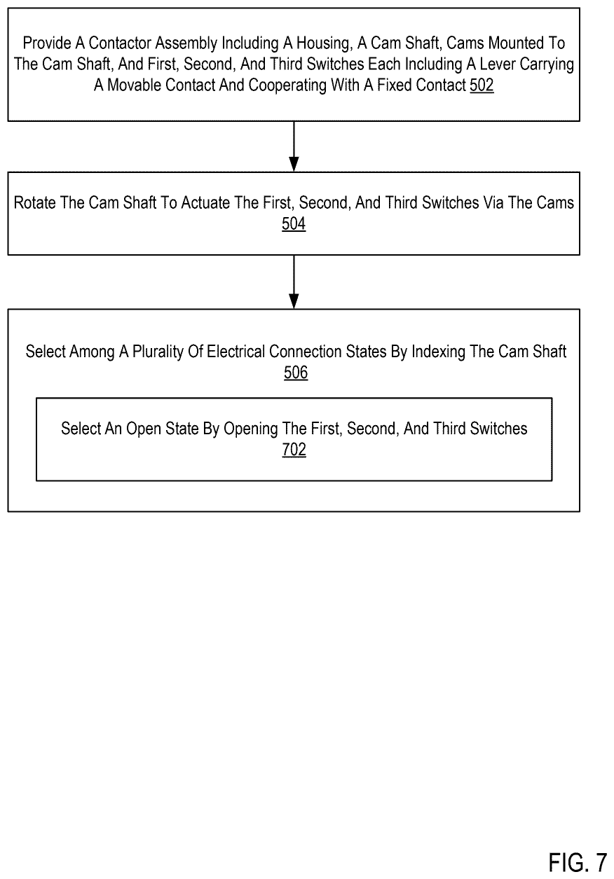

For further explanation, FIG. 7 sets forth a flowchart of another example method of operating a battery configuration contactor assembly according to at least one embodiment of the present disclosure. The method of FIG. 7 is similar to the method of FIG. 5 in that the method of FIG. 7 includes all of the steps of FIG. 5.

However, in the method of FIG. 7, selecting 506 among a plurality of electrical connection states by indexing the cam shaft includes selecting 702 an open state by opening the first, second, and third switches. Selecting 702 may be carried out by indexing the cam shaft 390/403 to an open-state setpoint so that cams 340 and 380 (or 420, 470, 471) release levers 310, 320, 360 (or 422, 463, 465), leaving couplers 314-316, 324-326, and 364-366 separated with no continuity along paths 318, 328, and 368. In this state the batteries 391 and 392 are isolated from HV+ 394 and HV− 393 as in FIGS. 3A-3C, and in the modular embodiment of FIGS. 4A-4C the same result is achieved with switches 492, 493.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A battery configuration contactor assembly comprising:
a housing;
a cam shaft;
a first cam and a second cam mounted to the cam shaft;
a first switch including a first lever carrying a first movable contact and cooperating with a first fixed contact;
a second switch including a second lever carrying a second movable contact and cooperating with a second fixed contact; and
a tension spring coupled between the first lever and the second lever;
wherein profiles and angular orientations of the first and second cams are selected such that the first switch and the second switch are in opposite states, and rotation of the cam shaft indexes the assembly among a plurality of electrical connection states.

2. The assembly of claim 1, wherein the tension spring biases the first and second levers toward opposite states to enforce mutual exclusivity between the first and second switches.

3. The assembly of claim 1, wherein at least one lever is formed by a stamp-and-form process.

4. The assembly of claim 1, further comprising a third switch including a third lever carrying a third movable contact and cooperating with a third fixed contact, wherein profiles and angular orientations of the cams are selected such that the first and third switches are concurrently open or concurrently closed and the second switch is in an opposite state.

5. The assembly of claim 4, wherein the plurality of electrical connection states comprises: open; parallel connection of first and second batteries; and series connection of the first and second batteries.

6. The assembly of claim 1, wherein creepage and clearance distances between conductive parts are provided by insulating features of the housing.

7. The assembly of claim 1, wherein at least one of the cams includes a profile having a lobe and a flat region arranged to alternately actuate the first and second levers.

8. The assembly of claim 4, wherein the third switch is biased toward an open position by a tension spring.

9. A battery configuration contactor assembly comprising:
a first housing portion and a second housing portion;
an actuator housing containing a motor and a cam-shaft receiver;
a cam shaft driven by the motor;
a first cam, a second cam, and a third cam on the cam shaft;
a first switch in the first housing portion including a first lever coupled between a first connection point and a second connection point;
a second switch in the second housing portion including a second lever coupled between a third connection point and a fourth connection point; and
a third switch in the second housing portion including a third lever coupled between a fifth connection point and a sixth connection point;
wherein the first, second, and third levers are respectively actuated by the first, second, and third cams on the common cam shaft.

10. The assembly of claim 9, further comprising a first cover enclosing the first housing portion and second and third covers enclosing the second housing portion.

11. The assembly of claim 9, wherein each switch includes a rocker carrying a movable contact that engages a corresponding fixed contact, and a spring biasing the lever toward an open position.

12. The assembly of claim 9, wherein axes of rotation of the first, second, and third levers are parallel and lie in a common plane.

13. The assembly of claim 9, wherein the second housing portion forms a dual-switch module and the first housing portion forms a single-switch module, both driven by the common cam shaft and motor.

14. The assembly of claim 9, wherein the cams have distinct angular orientations and/or profiles to provide at least one of: simultaneous closure of the first and third switches with the second switch open; closure of the second switch with the first and third switches open; or all switches open.

15. The assembly of claim 9, wherein lever-side couplers mate with corresponding connection-point couplers to complete or interrupt the respective circuits at the connection points.

16. A method of operating a battery configuration contactor assembly, comprising:
providing a contactor assembly including a housing, a cam shaft, cams mounted to the cam shaft, and first, second, and third switches each including a lever carrying a movable contact and cooperating with a fixed contact;
rotating the cam shaft to actuate the first, second, and third switches via the cams; and
selecting among a plurality of electrical connection states by indexing the cam shaft.

17. The method of claim 16, wherein selecting among the plurality of electrical connection states comprises:
selecting a parallel-connection state by closing the first and third switches and opening the second switch; and
selecting a series-connection state by opening the first and third switches and closing the second switch.

18. The method of claim 16, wherein selecting among the plurality of electrical connection states comprises:
selecting an open state by opening the first, second, and third switches.

19. The method of claim 16, wherein a tension spring is coupled between levers of the first and second switches to bias the first and second switches into opposite states.

20. The method of claim 16, wherein angular orientations of the cams synchronize the first and third switches and phase the second switch oppositely.
